(19) United States
(12) Patent Application Publication
(10) Pub. No.: US 2026/0028037 A1
(43) Pub. Date: Jan. 29, 2026

(54) NOTIFICATION APPARATUS, NOTIFICATION METHOD, AND RECORDING MEDIUM

(71) Applicant: HONDA MOTOR CO., LTD., Tokyo (JP)

(72) Inventors: Satoru Shinkawa, Wako-shi (JP); Shigenobu Mitsuzawa, Wako-shi (JP); Hiroshi Ono, Wako-shi (JP); Hiroki Taniguchi, Wako-shi (JP); Nozomi Nagatani, Wako-shi (JP)

(21) Appl. No.: 19/211,733

(22) Filed: May 19, 2025

(30) Foreign Application Priority Data
Jul. 26, 2024 (JP) 2024-121023

(51) Int. Cl. B60W 50/14; B60W 40/08; G01C 21/34; G01C 21/36

(52) U.S. Cl. CPC B60W 50/14; B60W 40/08; G01C 21/3415; G01C 21/3492; G01C 21/3617; B60W 2040/0872; B60W 2040/0881; B60W 2040/089; B60W 2050/143; B60W 2050/146; B60W 2540/21; B60W 2540/221; B60W 2540/229; B60W 2554/406

(57) ABSTRACT

A communication terminal functioning as a notification apparatus includes: an information acquisition unit functioning as a biological information acquisition unit acquiring biological information about a driver being a user, and an external environment recognition unit recognizing an external environment; a clock unit functioning as an external environment recognition unit recognizing another external environment; an intellectual function evaluation unit evaluating a physical condition of the driver, based on the biological information; and a notification control unit notifying the driver of the notification information, based on an evaluation result from the intellectual function evaluation unit. The notification control unit recognizes the external environment of the driver via the information acquisition unit and includes predetermined information based on the external environment in notification information, when it is detected that the physical condition is equal to or lower than a predetermined level based on the evaluation result from the intellectual function evaluation unit.

### INCORPORATION BY REFERENCE

The present application claims priority under 35 U.S.C. § 119 to Japanese Patent Application No. 2024-121023 filed on Jul. 26, 2024. The content of the application is incorporated herein by reference in its entirety.

### BACKGROUND OF THE INVENTION

### Field of the Invention

The present invention relates to a notification apparatus, a notification method, and a recording medium.

### Description of the Related Art

In recent years, efforts have gained momentum for providing access to sustainable transport systems that also take into account people in vulnerable situations among traffic participants. Towards this end, efforts are focused on research and development for further improving traffic safety, convenience, and the like through research and development relating to a preventive safety technology. For example, Japanese Patent Laid-Open No. 2019-200544 and Japanese Patent Laid-Open No. 2023-145868 disclose a driving assistance apparatus that estimates a cognitive state of a driver using vehicle information and biological information consisting of an imaging result, a respiration, and a pulse wave of the driver, or that gives advice, a warning, or the like to the driver. Japanese Patent Laid-Open No. 2019-200544 describes acquiring environment information indicating a traffic environment of a vehicle, and determining a danger state degree from an amount exceeding a speed limit of the vehicle by using the vehicle information and the environment information.

However, in the preventive safety technology, it is desired to take necessary response measures in accordance with a physical condition of the driver that affects a cognitive ability, a judgment ability, and the like of the driver. As one of the necessary response measures, a problem is to provide appropriate notification while avoiding excessive notification, an increase in processing quantity, and the like.

In order to solve the above problem, the present application has an object to provide appropriate notification while avoiding excessive notification, an increase in processing quantity, and the like. Thus, the present application further improves traffic safety and contributes to development of a sustainable transport system.

### SUMMARY OF THE INVENTION

According to an aspect of the present disclosure, a notification apparatus includes: a biological information acquisition unit configured to acquire biological information about a user; an external environment recognition unit configured to recognize an external environment; a physical condition evaluation unit configured to evaluate a physical condition of the user, based on the biological information; and a notification control unit configured to notify the user of notification information, based on an evaluation result from the physical condition evaluation unit, in which the notification control unit recognizes the external environment of the user via the external environment recognition unit and includes predetermined information based on the external environment in the notification information, when detecting that the physical condition of the user is equal to or lower than a predetermined level based on the evaluation result from the physical condition evaluation unit.

According to another aspect of the present disclosure, a notification method executed by a notification apparatus includes: a biological information acquisition step of acquiring biological information about a user; an external environment recognition step of recognizing an external environment; a physical condition evaluation step of evaluating a physical condition of the user, based on the biological information; and a notification control step of notifying the user of notification information, based on an evaluation result of the physical condition evaluation step, in which in the notification control step, the external environment of the user is recognized in the external environment recognition step and predetermined information based on the external environment is included in the notification information, when detecting that the physical condition of the user is equal to or lower than a predetermined level based on the evaluation result of the physical condition evaluation step.

According to another aspect of the present disclosure, a non-transitory computer readable a recording medium recording a program causes a notification apparatus controlled by a computer to function as: a biological information acquisition unit configured to acquire biological information about a user; an external environment recognition unit configured to recognize an external environment; a physical condition evaluation unit configured to evaluate a physical condition of the user, based on the biological information; and a notification control unit configured to notify the user of notification information, based on an evaluation result from the physical condition evaluation unit, in which the notification control unit recognizes the external environment of the user via the external environment recognition unit and includes predetermined information based on the external environment in the notification information, when detecting that the physical condition of the user is equal to or lower than a predetermined level based on the evaluation result from the physical condition evaluation unit.

According to the present invention, it is possible to provide appropriate notification while avoiding excessive notification, an increase in processing quantity, and the like.

### BRIEF DESCRIPTION OF THE DRAWINGS

FIG. 1 is a diagram for describing a usage form of a communication terminal;

FIG. 2 is a diagram showing an example of a configuration of the communication terminal;

FIG. 3 is a diagram showing a relationship between evaluation target items, a plurality of intellectual functions, and driving advice items;

FIG. 4 is a flowchart for describing a notification method executed by the communication terminal;

FIG. 5 is a diagram showing an example of dialog processing;

FIG. 6 is a flowchart for describing notification processing before driving;

FIG. 7 is a diagram showing an example of notification information; and

FIG. 8 is a flowchart for describing notification processing while driving.

### DETAILED DESCRIPTION OF THE INVENTION

### 1. Usage Form of Communication Terminal 1

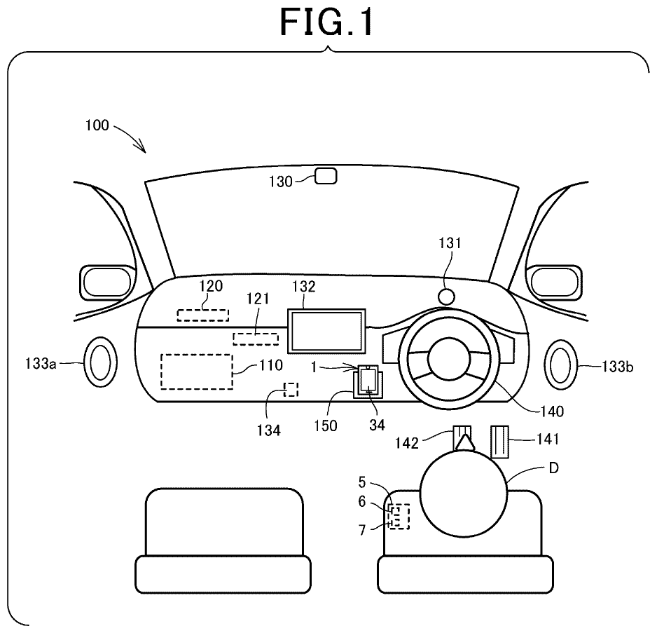

As shown in FIG. 1, a communication terminal 1 is attached via a terminal holder 150 at a position in front of a driver D being a user in a vehicle 100. The communication terminal 1 is a portable device such as a smartphone, a mobile phone, or a tablet terminal, and can be carried by the driver D. The vehicle 100 is a four-wheeled vehicle, and is an example of a target vehicle of the present disclosure. Note that the target vehicle may be a mobile body other than a four-wheeled vehicle, and may be, for example, an aircraft, a motorcycle, or a ship.

A wearable device 5 (computer) is worn by the driver D. The wearable device 5 is a device such as a smartwatch that is worn on a wrist, an arm, the head, or the like. Alternatively, the wearable device 5 is a sensing device attached to smart innerwear to be worn, the skin, inside the body, or the like. The wearable device 5 includes a vitals sensor 6 and a communication unit 7 (transmitter/receiver, circuit).

The vitals sensor 6 is a sensor that continuously measures biological information Db of the driver D at time intervals. This vitals sensor 6 includes a sensor capable of measuring the biological information Db relating to sleep, exercise, and stress of the driver D. For example, the sensor is included in a sensor group capable of measuring information relating to a heart rate, wrist skin temperature being an indicator of body temperature, an electrocardiogram, a blood oxygen level, activity amount, and sleep.

The communication unit 7 is a unit that performs wireless communication with the communication terminal 1, and performs, for example, short-range communication in accordance with a specification such as Bluetooth (R) or ultra-wideband (UWB). The wearable device 5 transmits the measured biological information Db to the communication terminal 1 by using the communication unit 7. Note that information about the communication terminal 1 being a communication destination is preregistered in the communication unit 7.

The vehicle 100 includes an electronic control unit (ECU) 110 that controls an operation of each unit of the vehicle 100, a communication unit 120 (transmitter/receiver, circuit), a navigation apparatus 121 (computer), a front camera 130 that images a front view of the vehicle 100, a driver monitor camera 131 that images the driver D, a display 132, speakers 133a and 133b, an acceleration sensor 134, and the like. The ECU 110 performs communication with the communication terminal 1 via the communication unit 120. The vehicle 100 includes a steering wheel 140, an acceleration pedal 141, a brake pedal 142, and the like as driving operation parts that the driver D operates when driving.

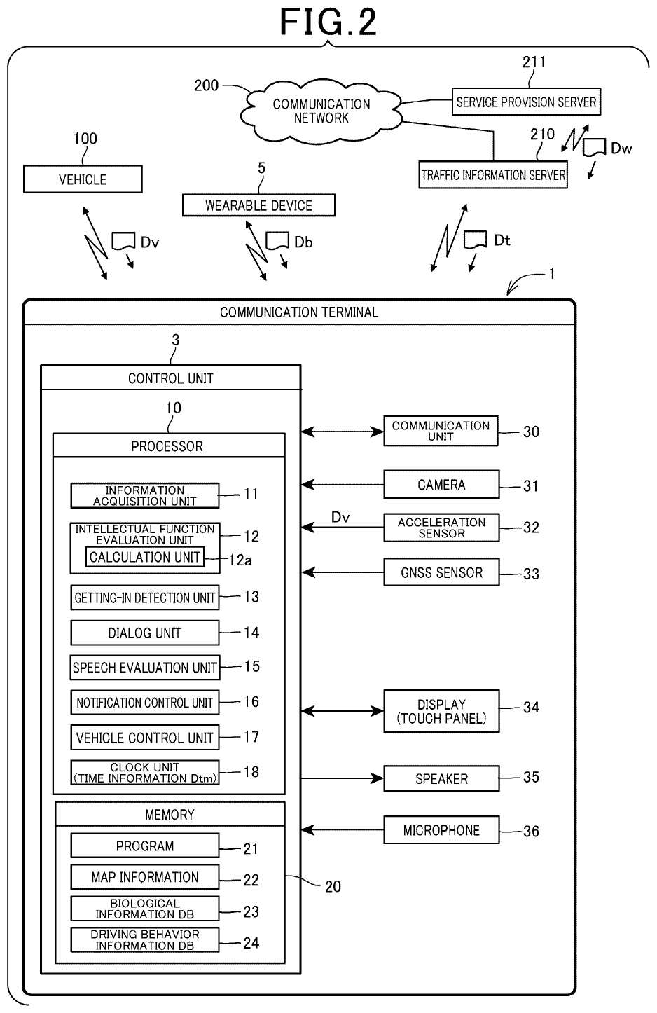

The communication terminal 1 can detect, via an acceleration sensor 32 (see FIG. 2) built in the communication terminal 1, behavior of the vehicle 100 that changes in accordance with operation of the driving operation parts, that is, operation of the steering wheel 140, the acceleration pedal 141, and the brake pedal 142 by the driver D. Note that a notification apparatus 2 may detect the behavior of the vehicle 100 by acquiring a detection result from the acceleration sensor 134 provided in the vehicle 100.

The communication terminal 1 notifies, via a display 34 included in the communication terminal 1, the driver D of notification information based on the biological information Db detected by the wearable device 5 or the like.

Furthermore, the communication terminal 1 includes various functions provided in a typical smartphone or the like, such as a map display function of displaying map information including current position on the display 34, a route guidance function of performing route guidance from a current position to a destination set by the driver D, and a music playback function. Note that the communication terminal 1 may include a function of causing the display 132 of the vehicle 100 to display the notification information, the map information, and the like described above.

### 2. Configuration of Communication Terminal 1

A configuration of the communication terminal 1 will be described with reference to FIG. 2. The communication terminal 1 includes a control unit 3 including a processor 10 and a memory 20, a communication unit 30, a camera 31, the acceleration sensor 32, a global navigation satellite system (GNSS) sensor 33, the display 34, a speaker 35, a microphone 36, and the like.

The communication unit 30 includes a communication module (transmitter/receiver, circuit) that performs wireless communication with external equipment.

The communication unit 30 includes a communication module that performs short-range wireless communication between the vehicle 100, the wearable device 5, and the like in accordance with a specification such as Bluetooth (R) or ultra-wideband (UWB). Furthermore, the communication unit 30 includes a communication module that performs communication between a traffic information server 210, a service provision server 211, and the like via a communication network 200 such as a mobile communication network. Note that information about the vehicle 100 and the wearable device 5 being communication destinations is preregistered at the communication unit 30 side.

The camera 31 can capture the driver D in a state in which the communication terminal 1 is placed in the terminal holder 150 (see FIG. 1). The acceleration sensor 32 detects, for example, six axes (acceleration in each of front-rear, left-right, and up-down axis direction, and angular velocity along each axis). The GNSS sensor 33 detects the current position of the communication terminal 1. A detected position from the GNSS sensor 33 is the current position of the vehicle 100 in the state in which the communication terminal 1 is placed in the terminal holder 150. The driver D can visually confirm the display 34 in the state in which the communication terminal 1 is placed in the terminal holder 150 (see FIG. 1). The display 34 is a touch panel, and the driver D can operate the communication terminal 1 through a touch operation on the display 34.

A program 21 of an application of the communication terminal 1, map information 22 including roads, a biological information database 23 (hereinafter, a biological information DB 23) in which the biological information Db acquired from wearable device 5 is stored in chronological order, and a driving behavior information database 24 (hereinafter, a driving behavior information DB 24) in which driving behavior information Dv to be described below is stored in chronological order are recorded in the memory 20.

The processor 10 is a computer that controls the communication terminal 1, and functions as an information acquisition unit 11, an intellectual function evaluation unit 12, a getting-in detection unit 13, a dialog unit 14, a speech evaluation unit 15, a notification control unit 16, a vehicle control unit 17, and the like by loading and executing the program 21. The processor 10 includes a clock unit 18 that tracks time.

The information acquisition unit 11 acquires the biological information Db measured by the wearable device 5 by using the communication unit 30, and records the biological information Db in the memory 20. Note that a measurement date and time of the biological information Db are also stored in the memory 20.

The information acquisition unit 11 acquires information acquired by the camera 31, the acceleration sensor 32, the GNSS sensor 33, and the microphone 36, and stores the information in the memory 20. The information acquired by the camera 31 is, for example, facial image data of the driver D. The facial image data may be used as the biological information Db for identifying a physical condition and the like of the driver D.

The information acquired by the acceleration sensor 32 is information indicating the behavior of the vehicle 100 caused by the operation of the steering wheel 140, the acceleration pedal 141, and the brake pedal 142 by the driver D, that is, the driving behavior information Dv indicating driving behavior of the driver D. The driving behavior information Dv is acquired continuously at time intervals, and is stored in the memory 20.

Note that the present invention is not limited to the information acquisition unit 11 acquiring the driving behavior information Dv by using the acceleration sensor 32 of the communication terminal 1, but the driving behavior information Dv acquired by the acceleration sensor 134 of the vehicle 100 may also be acquired by using short-range communication.

Furthermore, the information acquisition unit 11 can acquire information on the communication network 200 by using the communication unit 30. For example, the information acquisition unit 11 can acquire road traffic information Dt provided by the traffic information server 210 and various provided information provided by the service provision server 211. For example, the provided information from the service provision server 211 is examination information provided by a medical institution (for example, health diagnosis information) about a physical function, a cognitive function, and the like of the driver D; advice provided by a medical institution; or information for identifying an external environment (weather information Dw or the like) of the driver D, the vehicle 100, or the like. The examination information may be used as the biological information Db.

The road traffic information Dt is information including congestion information about the current position and a surrounding area of the communication terminal 1. The road traffic information Dt may include information other than the congestion information, such as accident information, restriction information, or information about rest locations. Information about the current location detected by the GNSS sensor 33 may be used for the current position.

The weather information Dw is information including the current weather and the weather forecast of the current position and the surrounding area of the communication terminal 1. The information acquisition unit 11 can acquire time information Dtm from the clock unit 18. The time information Dtm includes not only the time but also information such as the year, month, and day.

The weather information Dw and the time information Dtm are examples of environment information indicating an external environment of the driver D and the vehicle 100.

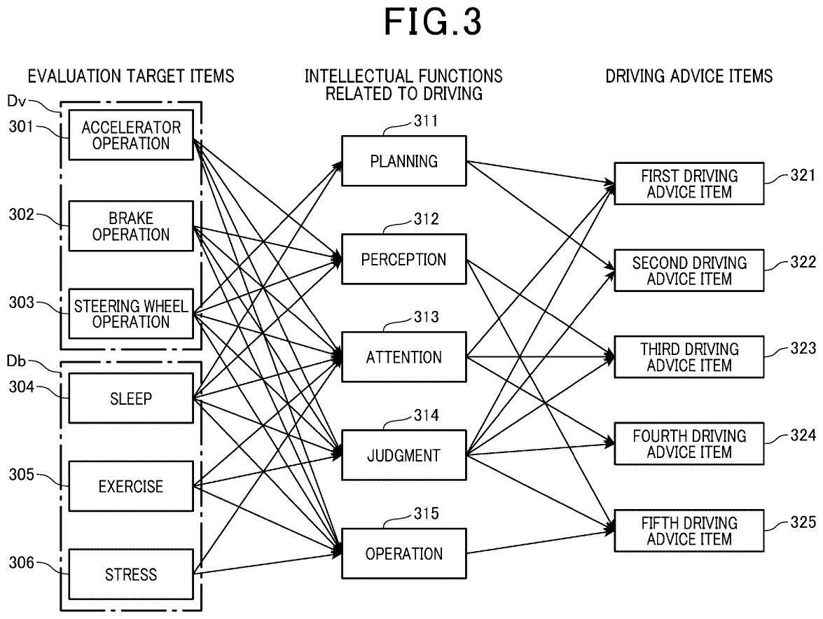

The intellectual function evaluation unit 12 performs processing of evaluating, based on the biological information Db, a plurality of intellectual functions relating to the physical condition of the driver D and related to a driving ability of the driver D. To be more specific, the intellectual function evaluation unit 12 includes a calculation unit 12a that calculates, based on the biological information Db, evaluation values of the plurality of intellectual functions consisting of a planning ability 311, a perception ability 312, an attention ability 313, a judgment ability 314, and an operation ability 315 shown in FIG. 3. The intellectual function evaluation unit 12 evaluates the plurality of intellectual functions based on the calculated evaluation values, and detects whether the physical condition of the driver D is favorable based on these evaluations.

FIG. 3 shows a relationship between evaluation target items, the plurality of intellectual functions to be evaluated by the intellectual function evaluation unit 12 (the planning ability 311, the perception ability 312, the attention ability 313, the judgment ability 314, and the operation ability 315), and driving advice items (a first driving advice item 321 to a fifth driving advice item 325).

Since the biological information Db acquired by the vitals sensor 6 includes information influencing sleep 304, exercise 305, and stress 306 shown in FIG. 3, it is possible to estimate a state of physiological indicators being the sleep 304, the exercise 305, and the stress 306 from the biological information Db. Since the driving behavior information Dv includes information about an accelerator operation 301, a brake operation 302, and a steering wheel operation 303 shown in FIG. 3, it is possible to estimate a state of the accelerator operation 301, the brake operation 302, and the steering wheel operation 303 from the driving behavior information Dv.

As shown in FIG. 3, the planning ability 311 is especially related to the sleep 304. The perception ability 312 is related to the sleep 304, the accelerator operation 301, the brake operation 302, and the steering wheel operation 303. The attention ability 313 is related to the sleep 304, the exercise 305, the stress 306, the accelerator operation 301, the brake operation 302, and the steering wheel operation 303. The judgment ability 314 and the operation ability 315 are related to the sleep 304, the exercise 305, the accelerator operation 301, the brake operation 302, and the steering wheel operation 303.

By using these relationships, the intellectual function evaluation unit 12 determines whether these intellectual functions are favorable by: grading the sleep 304, the exercise 305, and the stress 306 of the driver D based on the biological information Db about the driver D; acquiring first physical condition information corresponding to the evaluation value of each intellectual function based on the relationships shown in FIG. 3; and comparing each piece of the first physical condition information with a predetermined threshold value. The intellectual function evaluation unit 12 determines that the physical condition related to the intellectual functions of the driver D (hereinafter denoted as a first physical condition as appropriate) is favorable when a majority (three or more) of the intellectual functions are favorable, and determines that the first physical condition of the driver D is unfavorable when less than a majority (two or less) of the intellectual functions are favorable.

Note that physical condition in the present description is not limited to a narrow meaning, but includes information indicating at least one of physical condition or health with a broad meaning.

Known methods may be applied as appropriate for evaluation processing of the first physical condition, including calculation processing of the evaluation value for each intellectual function. The examination information about the physical function and the cognitive function of the driver D from the service provision server 211 (for example, the health diagnosis information) may be acquired, and the evaluation of each intellectual function, the evaluation of the first physical condition, and the like may be performed based on the biological information Db including this examination information. The intellectual functions may be changed, increased, or decreased as appropriate.

Furthermore, the intellectual function evaluation unit 12 can evaluate the planning ability 311, the perception ability 312, the attention ability 313, the judgment ability 314, and the operation ability 315 based on the driving behavior information Dv, and can evaluate the physical condition of the driver D taking into account both this evaluation and the evaluation based on the biological information Db.

Next, the driving advice items shown in FIG. 3 will be described.

The first driving advice item 321 is a suitable item for giving driving advice when the planning ability 311 or the attention ability 313 is low, and, for example, indicates an operation speed of the acceleration pedal 141 when starting to move.

The second driving advice item 322 is a suitable item for giving driving advice when the planning ability 311 or the judgment ability 314 is low, and, for example, indicates an operation speed of the brake pedal 142 when stopping.

The third driving advice item 323 is a suitable item for giving driving advice when the perception ability 312, the attention ability 313, or the judgment ability 314 is low, and, for example, indicates an operation speed of the steering wheel 140 when negotiating curves, overtaking another vehicle, and the like.

The fourth driving advice item 324 is a suitable item for giving driving advice when the attention ability 313 is low, and, for example, indicates an inter-vehicle distance from a vehicle traveling in front.

The fifth driving advice item 325 is a suitable item for giving driving advice when the perception ability 312, the judgment ability 314, or the operation ability 315 is low, and, for example, indicates left-right drifting of the vehicle 100.

A usage form of these driving advice items will be described below.

Returning to FIG. 2, the getting-in detection unit 13 performs processing of detecting whether the driver D has not gotten in or has gotten in the vehicle, by detecting a timing when the driver D gets in the vehicle 100 (hereinafter, a getting-in timing). The processing of detecting the getting-in timing of the driver D is not particularly limited, but the getting-in detection unit 13, for example, acquires image information from a camera in the vehicle 100 (for example, the driver monitor camera 131) or a camera provided in the vehicle 100 that captures an outside of the vehicle, detects the getting-in timing of the driver D by using image recognition technology. The getting-in detection unit 13 may receive a signal from a weight sensor provided at the driver seat from the vehicle 100, and may detect the getting-in timing of the driver D based on the received signal.

The dialog unit 14 performs dialog processing of having a dialog with the driver D. The dialog processing is processing of performing speech output for dialog encouraging a speech response from the driver D by using the speaker 133a. This dialog processing includes processing of collecting speech information of the driver D via the microphone 36.

In the present embodiment, the dialog processing is executed at the getting-in timing of the driver D detected by the getting-in detection unit 13, or at a timing immediately before or immediately after the getting-in timing. With this, it is possible to acquire the speech information of the driver D when getting in the vehicle 100, immediately before getting in the vehicle 100, or immediately after getting in the vehicle 100, that is, it is possible to acquire the speech information of the driver D immediately before driving the vehicle 100.

The speech evaluation unit 15 performs processing of acquiring physical condition speech information relating to the physical condition of the driver D, by performing speech analysis on the speech information of the driver D acquired through the dialog processing. A content of this processing is not particularly limited, but in the present embodiment, the physical condition speech information indicating an energy level and a mental stability level is acquired by extracting characteristics of the speech and performing arithmetic processing of calculating information indicating the energy level and the mental stability level of the driver D from the extracted characteristics. The speech evaluation unit 15 determines, based on the physical condition speech information, whether a physical condition influenced by the energy level and the mental stability level (denoted as a second physical condition as appropriate) is favorable.

Note that the processing performed by the speech evaluation unit 15 is not limited to the above processing, and can be broadly applied to processing of acquiring information for evaluating the physical condition of the driver D from the speech of the driver D.

The notification control unit 16 generates notification information corresponding to the physical condition of the driver D based on a combination of an evaluation result of the intellectual function evaluation unit 12 and an evaluation result of the speech evaluation unit 15, and displays the generated notification information on the display 34 or emits speech corresponding to the notification information from the speaker 133a.

The vehicle control unit 17 has a control function for the vehicle 100, and more specifically, can perform control related to a driving assistance function of the vehicle 100 by communicating with the vehicle 100 using the communication unit 30. The driving assistance function includes an automatic braking function, a lane keeping assistance function, and adaptive cruise control (ACC).

### 3. Operation of Communication Terminal 1

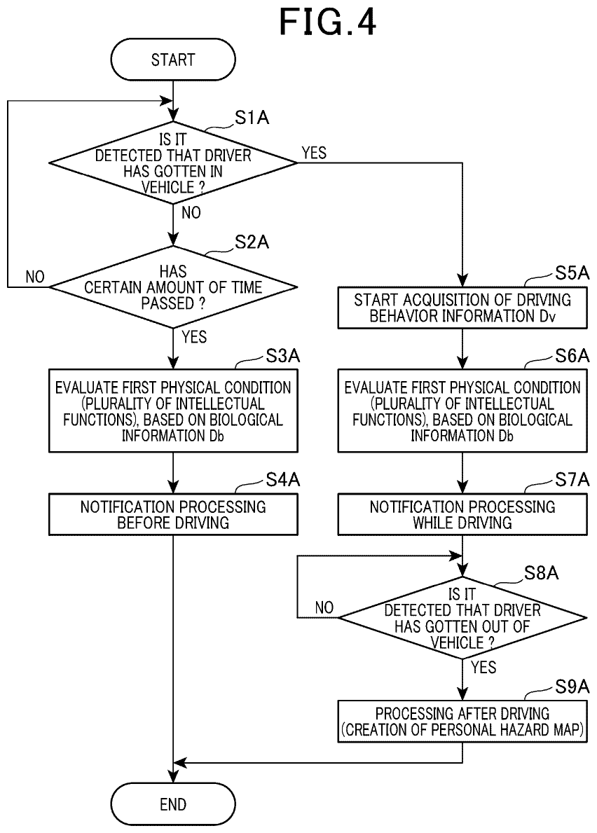

A notification method executed by the communication terminal 1 will be described in accordance with a flowchart shown in FIG. 4. The flowchart shown in FIG. 4 is repeatedly executed at an appropriate interrupt timing when the program 21 of the application is being executed. When the wearable device 5 is present within a short-range wireless communication area of the communication terminal 1, processing of acquiring the biological information Db measured by the wearable device 5 is executed by the information acquisition unit 11.

As shown in FIG. 4, the notification control unit 16 of the communication terminal 1 determines whether the getting-in detection unit 13 has detected that the driver D has gotten in the vehicle 100 (step S1A). When the getting-in detection unit 13 does not detect that the driver D has gotten in the vehicle 100 (NO in step S1A), the notification control unit 16 determines whether a certain amount of time has passed since previously displaying advice on the display 34 (step S2A). When the certain amount of time has not passed (NO in step S2A), the notification control unit 16 transitions to the processing of step S1A.

When the getting-in detection unit 13 does not detect that the driver D has gotten in the vehicle 100 (NO in step S1A) and the certain amount of time passes (YES in step S2A), the notification control unit 16 performs, via the intellectual function evaluation unit 12, processing of acquiring the first physical condition information corresponding to the evaluation value of each of the plurality of intellectual functions based on the biological information Db of a predetermined period in the biological information DB 23 recorded in the memory 20, and evaluating the first physical condition of the driver D based on the first physical condition information (step S3A).

With this, the intellectual function evaluation unit 12 detects whether a majority (three or more) of the intellectual functions is favorable in the predetermined period and detects whether the first physical condition is favorable in accordance with whether a majority of the intellectual functions is favorable for the planning ability 311, the perception ability 312, the attention ability 313, the judgment ability 314, and the operation ability 315.

Note that the predetermined period is set to an appropriate period, but it is possible to acquire an evaluation result of a relatively long-term physical condition of the driver D, by setting the predetermined period to a period in which the relatively long-term physical condition of the driver D can be identified, for example, by setting the predetermined period to a period of the past several hours, several days, or several months starting from the current point in time.

In step S3A, the intellectual function evaluation unit 12 may perform processing of acquiring the first physical condition information corresponding to the evaluation value of each of the plurality of intellectual functions based on the biological information Db of the predetermined period in the biological information DB 23 and the driving behavior information Dv of the predetermined period in the driving behavior information DB 24, and evaluating the first physical condition of the driver D based on the first physical condition information.

Next, the notification control unit 16 performs notification processing before driving, based on the evaluation result from the intellectual function evaluation unit 12 (step S4A). The notification processing before driving will be described below.

On the other hand, when the getting-in detection unit 13 detects that the driver D has gotten in the vehicle 100 (YES in step S1A), the notification control unit 16 starts acquisition of the driving behavior information Dv, and performs, via the intellectual function evaluation unit 12, processing of acquiring the first physical condition information corresponding to the evaluation value of each of the plurality of intellectual functions based on the biological information Db of the predetermined period in the biological information DB 23 recorded in the memory 20, and evaluating the first physical condition of the driver D based on the first physical condition information (step S6A).

With this, similar to step S3A, the intellectual function evaluation unit 12 detects whether a majority (three or more) of the intellectual functions is favorable in the predetermined period and detects whether the first physical condition is favorable in accordance with whether a majority of the intellectual functions is favorable for the planning ability 311, the perception ability 312, the attention ability 313, the judgment ability 314, and the operation ability 315. Note that the predetermined period may be set to an appropriate period, similar to step S3A.

In step S6A, the intellectual function evaluation unit 12 may perform processing of acquiring the first physical condition information corresponding to the evaluation value of each of the plurality of intellectual functions based on the biological information Db of the predetermined period in the biological information DB 23 and the driving behavior information Dv of the predetermined period in the driving behavior information DB 24, and evaluating the first physical condition of the driver D based on the first physical condition information.

Subsequently, the notification control unit 16 performs notification processing while driving, based on the evaluation result from the intellectual function evaluation unit 12 (step S7A). The notification processing while driving will be described below.

The notification control unit 16 determines whether it is detected that the driver D has gotten out of the vehicle 100 after executing the notification processing while driving of step S7A (step S8A). When it is detected that the driver D has gotten out of the vehicle 100 (YES in step S8A), driving processing after driving is performed (step S9A). A method of detecting the driver D getting out of the vehicle 100 is not particularly limited, but a method may, for example, be applied of using the front camera 130, a weight sensor at the driver seat, or the like.

The processing after driving in step S9A is processing of creating a hazard map on which locations where inappropriate driving behavior has occurred are recorded, based on the driving behavior information Dv acquired while driving. For example, the information acquisition unit 11 continuously acquires the driving behavior information Dv while the vehicle is traveling, and the notification control unit 16 detects the locations where inappropriate driving behavior such as abrupt braking and left-right drifting has occurred based on the driving behavior information Dv and information about the current position detected by the GNSS sensor 33, and performs the processing of creating a hazard map on which a detection result is recorded. The created hazard map may be data recorded in the map information 22 of the memory 20, or may be data recorded in the memory 20 separate from the map information 22.

When a hazard map is created, it is possible, by using the hazard map while driving, to, for example, via the notification control unit 16, notify the driver D of a location where inappropriate driving behavior has occurred and encourage the driver D to drive safely when traveling nearby this location. Note that the processing after driving is not limited to the processing of creating a hazard map, and appropriate processing may be applied.

Note that in the step S6A described above, the notification control unit 16 may perform the dialog processing encouraging the speech response from the user and acquire the speech information of the driver D as a response to the speech output via the dialog unit 14, and evaluate the second physical condition indicating a relatively short-term physical condition of the driver D based on the speech information of the driver D via the speech evaluation unit 15. The physical condition of the driver D may be evaluated based on the combination of the evaluation result of the first physical condition and the evaluation result of the second physical condition.

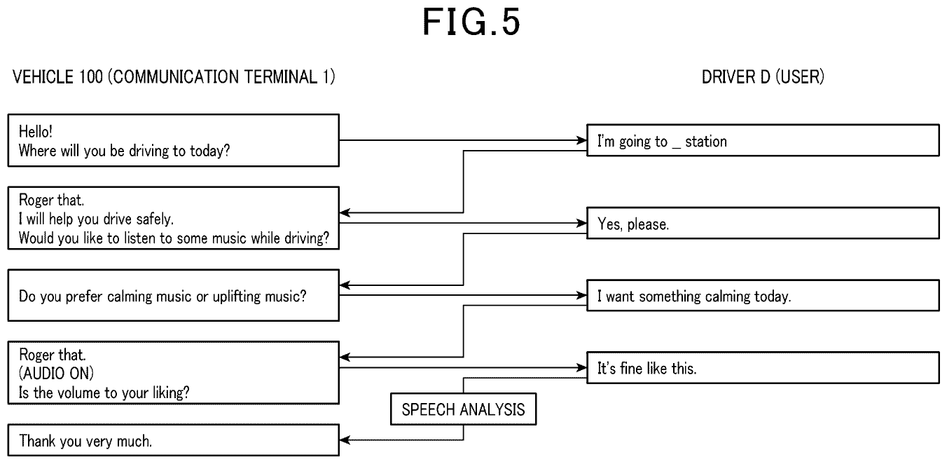

FIG. 5 is a diagram showing an example of the dialog processing of the dialog unit 14.

A left side of FIG. 5 shows notification information emitted by the dialog unit 14 via the speaker 133a. Note that the notification information may be displayed on the display 34. A right side of FIG. 5 shows utterance content produced by the driver D. The speech produced by the driver D is collected by the microphone 36.

A dialog content of the dialog unit 14 may be changed appropriate within the scope of encouraging a speech response from the driver D. In the example of FIG. 5, the dialog content includes a message asking a destination (“Where will you be driving to today?”) and a message asking whether to playback audio and an audio playback preference (“Would you like to listen to music while driving?”, “Do you prefer relaxing music or uplifting music?”, and the like).

Thus, the communication terminal 1 can acquire information relating to the destination, the audio playback, and the audio preference produced by the driver D, by using known speech recognition technology. The communication terminal 1 can start route guidance processing to the destination and audio playback processing, by executing processing corresponding to the acquired information.

Note that when performing the route guidance processing, it is preferable to acquire the road traffic information Dt provided by the traffic information server 210, search for a recommended route by using congestion information and the like included in the road traffic information Dt, or the like.

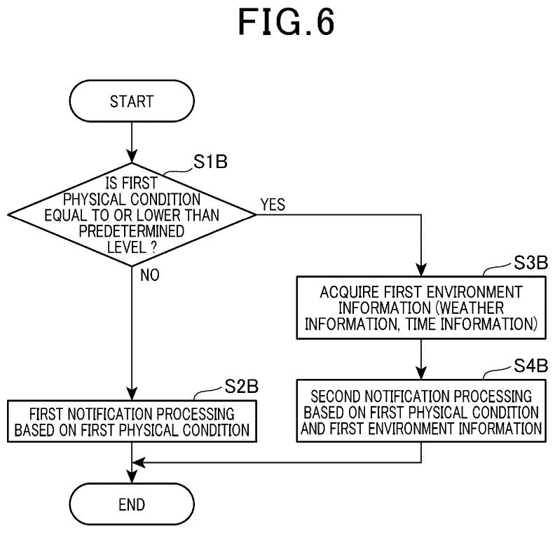

Next, the notification processing before driving will be described in accordance with a flowchart shown in FIG. 6.

As shown in FIG. 6, the notification control unit 16 determines, via the intellectual function evaluation unit 12, whether the first physical condition is equal to or lower than a predetermined level (step S1B). Here, the predetermined level is a threshold value for determining whether the physical condition of the driver D is unfavorable. For example, when less than a majority (two or less) of the intellectual functions is favorable, the notification control unit 16 determines that the first physical condition is equal to or lower than the predetermined level. However, this predetermined level is not limited to the threshold value for determining whether the physical condition is unfavorable in a strict sense, but may be a threshold value for determining whether the driver D is a high-risk user for at least one of the physical condition or the driving.

For example, when the driver D having two or more favorable intellectual functions or one or more favorable intellectual functions is considered the above high-risk user, the first physical condition may be determined to be equal to or lower than the predetermined level. For example, when the driver D whose first physical condition shows deterioration, that is, the driver D whose first physical condition is gradually changing towards being unfavorable is considered the above high-risk user, the first physical condition may be determined to be equal to or lower than the predetermined level. In this way, the predetermined level may be set as appropriate.

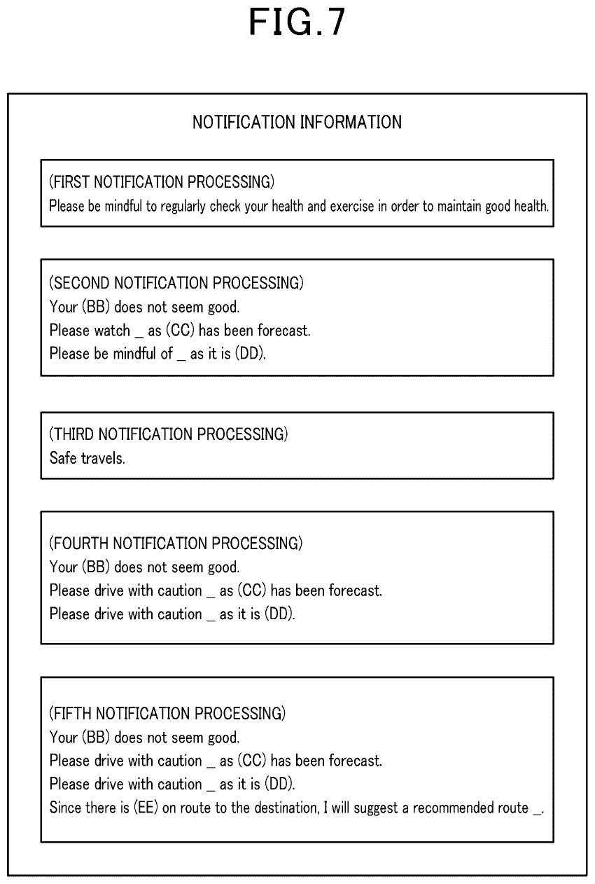

When the first physical condition exceeds the predetermined level (NO in step S1B), the notification control unit 16 performs first notification processing based on the first physical condition (step S2B). The first notification processing is processing of notifying the driver D of minimal notification information for a user with a relatively low physical condition and driving risk. As exemplified in FIG. 7, the notification information of the first notification processing is a concise message such as “Please be mindful to regularly check your health and exercise in order to maintain good health.” Thus, the driver D is less likely to feel bothered.

When the first physical condition is equal to or lower than the predetermined level (YES in step S1B), the notification control unit 16 acquires first environment information consisting of the weather information Dw and the time information Dtm (step S3B), and performs second notification processing based on the first physical condition and the first environment information (step S4B).

The second notification processing is processing, which is different from the first notification processing, of notifying the driver D of information, and is processing of notifying the driver D of notification information for a user with a relatively high physical condition and driving risk. In the notification information of the second notification processing exemplified in FIG. 7, wording corresponding to at least the intellectual function with the lowest evaluation is input at a position indicated by reference sign BB. For example, when the intellectual function with the lowest evaluation is the attention ability 313, the driver D is notified of advice such as “Your focus does not seem good.”

In the notification information of the second notification processing exemplified in FIG. 7, information acquired from the weather information Dw is input at a position indicated by reference sign CC and information acquired from the time information Dtm is input at a position indicated by reference sign DD. Thus, the driver D is notified of advice relating to everyday life, such as “Please watch your step as rain has been forecast. Please be mindful of your field of vision as it is nighttime.”

The above is the notification processing before driving.

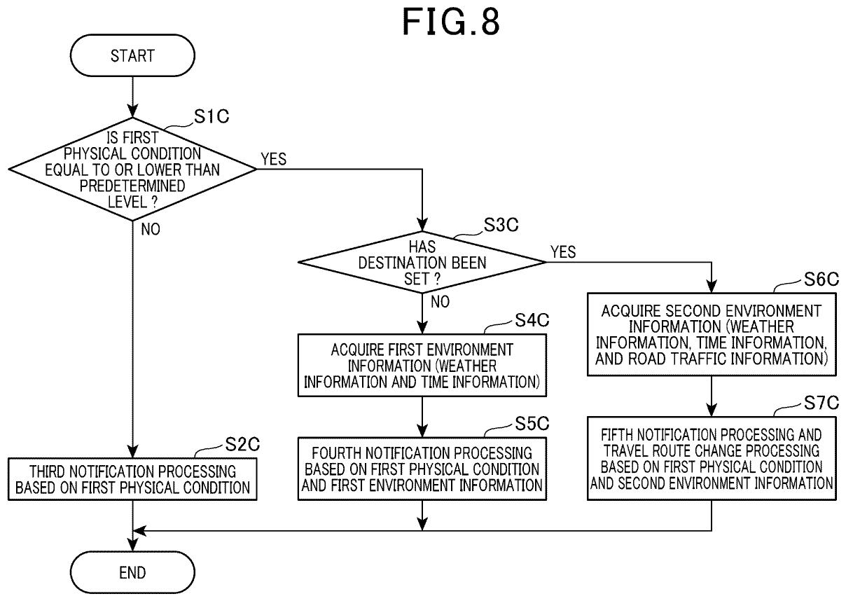

The notification processing while driving will be described in accordance with a flowchart shown in FIG. 8.

As shown in FIG. 8, the notification control unit 16 determines, via the intellectual function evaluation unit 12, whether the first physical condition is equal to or lower than the predetermined level (step S1C). When the first physical condition exceeds the predetermined level (NO in step S1C), the notification control unit 16 performs third notification processing based on the first physical condition (step S2C). The third notification processing is processing, which is different from the first notification processing and the second notification processing, of notifying the driver D of information, and is processing of notifying the driver D of minimal notification information for a user with a relatively low physical condition and driving risk. As exemplified in FIG. 7, the notification information of the third notification processing is a concise message such as “Safe travels.”

When the first physical condition is equal to or lower than the predetermined level (YES in step S1C), the notification control unit 16 determines whether a destination has been set (step S3C). When the destination has not been set (NO in step S3C), the notification control unit 16 acquires the first environment information consisting of the weather information Dw and the time information Dtm (step S4C), and performs fourth notification processing based on the first physical condition and the first environment information (step S5C).

The fourth notification processing is processing, which is different from the first notification processing to the third notification processing, of notifying the driver D of information, and is processing of notifying the driver D of notification information for a user with a relatively high physical condition and driving risk. As exemplified in FIG. 7, in the notification information of the fourth notification processing, wording corresponding to at least the intellectual function with the lowest evaluation is input at a position indicated by reference sign EE. Thus, when the intellectual function with the lowest evaluation is the attention ability 313, the driver D is notified of advice such as “Your focus does not seem good. Please drive carefully.”

In the notification information of the fourth notification processing exemplified in FIG. 7, the wording corresponding to at least the intellectual function with the lowest evaluation is input at the position indicated by reference sign BB, the information acquired from the weather information Dw is input at the position indicated by reference sign CC, and the information acquired from the time information Dtm is input at the position indicated by reference sign DD. For example, the driver D is notified of advice relating to driving, such as “Your focus does not seem good. Please drive with caution to avoid slipping as rain has been forecast. Please drive with caution while paying attention to light of oncoming vehicles as it is nighttime.”

In the case of the fourth notification processing, the driver D may be notified of advice by using a driving advice item corresponding to at least the intellectual function with the lowest evaluation from among the driving advice items 321 to 325 shown in FIG. 3. For example, when the intellectual function with the lowest evaluation is the operation ability 315, the driver D is notified of “Be mindful of left-right drifting of the vehicle 100 when driving today.”, since the driving advice item corresponding to the operation ability 315 is the fifth driving advice item 325 (left-right drifting of the vehicle 100).

When the destination has not been set (NO in step S3C), the notification control unit 16 acquires second environment information consisting of the weather information Dw, the time information Dtm, and the road traffic information Dt (step S6C), and performs fifth notification processing based on the first physical condition and the second environment information (step S7C).

The fifth notification processing is processing, which is different from the first notification processing to the fourth notification processing, of notifying the driver D of information, and is processing of notifying the driver D of notification information for a user with a relatively high physical condition and driving risk.

As exemplified in FIG. 7, in the notification information of the fifth notification processing, the wording corresponding to at least the intellectual function with the lowest evaluation is input at the position indicated by reference sign BB, the information acquired from the weather information Dw is input at the position indicated by reference sign CC, the information acquired from the time information Dtm is input at the position indicated by reference sign DD, and information acquired from the road traffic information Dt is input at a position indicated by reference sign EE. For example, the driver D is notified of advice relating to driving to the destination, such as “Your focus does not seem good. Please drive with caution to avoid slipping as rain has been forecast. Please drive with caution while paying attention to light of oncoming vehicles as it is nighttime. Since there is congestion on route to the destination, I will suggest a recommended route for avoiding the congestion.”

In the case of the fifth notification processing, similar to the fourth notification processing, the driver D may be notified of advice by using a driving advice item corresponding to at least the intellectual function with the lowest evaluation from among the driving advice items 321 to 325 shown in FIG. 3.

For example, when the intellectual function with the lowest evaluation is the planning ability 311, the driver D is notified of advice such as “Please be mindful of the operation speed of your acceleration pedal when starting to move and the operation speed of your brake pedal when stopping for today's driving.” since the driving advice items corresponding to the planning ability 311 are the first driving advice item 321 (the operation speed of the acceleration pedal 141 when starting to move) and the second driving advice item 322 (the operation speed of brake pedal 142 when stopping). With this, it is possible to provide proper driving advice in accordance with the physical condition.

In step S7C, the notification control unit 16 performs, in addition to the fifth notification processing, travel route change processing of changing a travel route based on the destination and the road traffic information Dt.

This travel route change processing is processing of searching for a recommended route by using the congestion information, the accident information, the restriction information, the information about rest locations, and the like included in the road traffic information Dt as appropriate, and changing the travel route from the current position to the destination to the found recommended route, with the purpose of changing to a safer travel route by using the road traffic information Dt.

For example, in the travel route change processing, the travel route from the current position to the destination is changed to a travel route taking into account the intellectual function with the lowest evaluation, by searching for a travel route for avoiding a congested location, a dangerous area such as an area with frequent accidents, searching for a travel route that passes by a rest location, or the like. Hypothetically speaking, when the attention ability 313 of the driver D is low, a travel route for avoiding narrow roads and streets, a travel route prioritizing wide roads, or the like may be searched for, since a reaction speed of the driver D may be decreased and the driver D may have difficulty with handling a person running out into the street. The driver D may be notified of a dangerous area, notified of a traffic congestion area, be advised to take a break, or the like.

In this way, when the physical condition of the driver D is equal to or lower than the predetermined level, it is possible to provide appropriate notification, since the road traffic information Dt is acquired, and the travel route is changed to the recommended route, the driver D is notified of the notification information, or the like based on the acquired road traffic information Dt.

On the other hand, when the physical condition of the driver D is not equal to or lower than the predetermined level, it is possible to consider the driving risk to be low. In this case, it is possible to avoid an increase in processing quantity, excessive notification, and the like, since the road traffic information Dt is not acquired and the driver D is not notified of the notification information by using the road traffic information Dt.

Note that in the travel route change processing of step S7C, the driver D may be capable of selecting whether to search for a travel route and/or whether to change to the found travel route as appropriate.

The above is the notification processing while driving.

### 4. Modified Examples of Notification Processing

The notification information in the notification processing before driving and the notification processing while driving described above may be modified as appropriate. For example, the environment information acquired when it is detected that the physical condition of the driver D is equal to or lower than the predetermined level need not be limited to the weather information Dw, the time information Dtm, and the road traffic information Dt, but it is possible to apply information indicating the external environment of at least one of the driver D or the vehicle 100 as appropriate.

In the notification processing before driving and the notification processing while driving, when it is detected that the physical condition of the driver D is equal to or lower than the predetermined level, the notification control unit 16 may perform, via the dialog unit 14, speech output encouraging a response from the driver D relating to at least the intellectual function with the lowest evaluation, and include response handling information based on the response from the user in the notification information.

For example, the notification control unit 16 asks, as the speech output encouraging the response from the driver D relating to the intellectual function with the lowest evaluation, a question relating to the intellectual function, for example, a question for confirming a decrease in that intellectual function. When a positive response is acquired to the decrease in that intellectual function, the notification control unit 16 may identify the physiological indicators (for example, the sleep 304, the exercise 305, and the stress 306 shown in FIG. 3) to be improved based on the intellectual function and notify the driver D of advice relating to the identified physiological indicators.

When performing the fourth notification processing and the fifth notification processing shown in FIG. 8, the settings changing processing of the driving assistance function may be executed.

The settings changing processing of the driving assistance function is processing of changing, via the vehicle control unit 17, the driving assistance function of the vehicle 100 to a predetermined setting prioritizing safety. The predetermined setting is, for example, a longer inter-vehicle distance during adaptive cruise control. Note that when performing the third notification processing after performing the settings changing processing of the driving assistance function, that is, when the physical condition of the driver D has improved, the settings of the driving assistance function may be returned to the pre-changed settings (for example, user-set values).

When performing the fifth notification processing, the notification processing for a surrounding area may be executed.

The notification processing for a surrounding area is processing of notifying, by the notification control unit 16 using the communication unit 30, an occupant of another vehicle in a surrounding area of the vehicle 100, a family of the driver D, and the like of surrounding area advice relating to the driving of the driver D, by wirelessly communicating the surrounding area advice. For example, by wirelessly transmitting information corresponding to the surrounding area advice to an in-vehicle system of another vehicle, a mobile terminal carried by a passenger or a family member, or the like, the surrounding area advice is emitted from the in-vehicle system, the mobile terminal (e.g., a smartphone), or the like. With this, it is possible to notify the surrounding area calling for attention, when the physical condition of the driver D is unfavorable. Note that inter-vehicle communication may be used for the communication to the in-vehicle system of the other vehicle or the like.

### 5. Effects of Embodiment

As described above, the communication terminal 1 includes: the information acquisition unit 11 that functions as a biological information acquisition unit that acquires the biological information Db about the driver D being the user, and an external environment recognition unit that recognizes the external environment indicated by the weather information Dw, the road traffic information Dt, and the like; the clock unit 18 that functions as an external environment recognition unit that recognizes the external environment indicated by the time information Dtm; the intellectual function evaluation unit 12 that evaluates the physical condition of the driver D, based on the biological information Db; and the notification control unit 16 that notifies the driver D of the notification information, based on the evaluation result from the intellectual function evaluation unit 12. The notification control unit 16 recognizes the external environment of the driver D via the information acquisition unit 11 and includes predetermined information based on the external environment in the notification information, when it is detected that the physical condition of the driver D is equal to or lower than the predetermined level based on the evaluation result from the intellectual function evaluation unit 12.

According to this configuration, processing of recognizing the external environment of the driver D and the like becomes unnecessary and it is possible to provide appropriate notification while avoiding excessive notification, an increase in processing quantity, and the like when the physical condition of the driver D is not equal to or lower than the predetermined level, since the external environment of the driver D is recognized when the physical condition of the driver D is equal to or lower than the predetermined level and the predetermined information based on the external environment is included in the notification information.

Note that the intellectual function evaluation unit 12 can be referred to as a physical condition evaluation unit and a first physical condition evaluation unit, and the speech evaluation unit 15 can be referred to as a physical condition evaluation unit and a second physical condition evaluation unit.

The intellectual function evaluation unit 12 evaluates the plurality of intellectual functions relating to the physical condition of the driver D, based on the biological information Db. As shown in FIG. 7, the notification control unit 16 notifies, as the notification information, the driver D of the predetermined information based on the external environment, after notifying the driver D of information based on the intellectual function with the lowest evaluation. According to this configuration, it is possible to prioritize notifying the driver D of information based on an important intellectual function relating to the physical condition over notifying the driver D of the predetermined information based on the environment information, and to provide appropriate notification.

The getting-in detection unit 13 is provided that functions as a getting-in detection unit that detects whether the driver D has not gotten in or has gotten in the vehicle 100. The external environment being a recognition target of the information acquisition unit 11 is changed in accordance with whether the driver D has not gotten in the vehicle 100 as shown FIG. 6 or has gotten in the vehicle 100 as shown in FIG. 8. According to this configuration, it is possible to provide information based on the environment information of which the user is preferably notified in accordance with whether the user has not gotten in or has gotten in the target vehicle. With this, it is possible to provide appropriate notification.

The notification information includes advice relating to driving of the driver D. The external environment being the target recognition target includes the road traffic information Dt, when the driver D has gotten in the vehicle 100 and the destination of the driver D has been set. According to this configuration, it is possible to notify the driver D of notification information taking into account the physical condition and road traffic circumstances to the destination, and to provide appropriate notification, when the physical condition of the driver D is unfavorable and the driver D has gotten in the vehicle 100.

The notification control unit 16 performs change processing of changing to a travel route taking into account the physical condition of the driver D, based on the road traffic information Dt and the physical condition of the driver D acquired from the evaluation result from the intellectual function evaluation unit 12. According to this configuration, it is possible to provide a more appropriate travel route.

The intellectual function evaluation unit 12 evaluates the plurality of intellectual functions relating to the physical condition of the driver D, based on the biological information Db. The dialog unit 14 is provided that functions as a speech output unit that performs the speech output encouraging the response from the driver D relating to the intellectual function with the lowest evaluation, when it is detected that the physical condition of the driver D is equal to or lower than the predetermined level. The notification control unit 16 includes the response handling information based on the response from the driver D in the notification information. According to this configuration, it is possible to notify the driver D of more appropriate information, via the dialog with the driver D.

When the response from the driver D is the positive response relating to the intellectual function with the lowest evaluation, the notification control unit 16 identifies the physiological indicators to be improved based on the intellectual function and notifies the driver D of the advice relating to the identified physiological indicators. According to this configuration, it is possible to notify the driver D of information for improving the decreased intellectual function of the driver D, and to notify the driver D of more appropriate information.

Note that the processing of the information acquisition unit 11 is an example of a biological information acquisition step and an external environment recognition step according to the present disclosure. The processing of the intellectual function evaluation unit 12 is an example of a physical condition evaluation step according to the present disclosure. The processing of the notification control unit 16 is an example of a notification control step according to the present disclosure.

The notification information includes the surrounding area advice relating to the driving of the driver D. When performing the third notification processing, the notification control unit 16 performs processing of transmitting the surrounding area advice to an external destination by using wireless communication. According to this configuration, it is possible to notify the surrounding area calling for attention, when the physical condition is unfavorable and the driver D is driving the vehicle 100 while still feeling unwell.

The communication terminal 1 includes the vehicle control unit 17 that changes the driving assistance function of the vehicle 100 driven by the driver D to the predetermined setting prioritizing safety, when performing at least one of the second notification processing or the third notification processing. According to this configuration, it is possible to perform driving assistance prioritizing safety, in other words, to perform driving assistance matched to a user with an unfavorable physical condition, when the physical condition is unfavorable and the driver D is driving the vehicle 100 while still feeling unwell.

### 6. Other Embodiments

The above-described embodiment is merely one embodiment according to the present invention and can be freely modified and applied without departing from the gist of the present invention.

For example, the configuration of the communication terminal 1 shown in FIG. 2 is one example and may be modified as appropriate. A configuration realized by software, a configuration realized by hardware, or a configuration realized by combining software and hardware can be broadly applied to the configuration of each unit shown in FIG. 2 and the like. The way of dividing processing units in the flowchart, the processing order thereof, and the like are not limited to the illustrated example, and may be modified as appropriate.

A case has been described in which the notification apparatus of the present invention is realized by the communication terminal 1 being a portable device, but the present invention is not limited thereto. The notification apparatus of the present invention may be realized by the vehicle 100. A case has been described in which the notification apparatus acquires the biological information Db from the wearable device 5, but the notification apparatus itself may have a function of measuring the biological information Db.

A case has been described in which the program 21 for realizing the notification method of the present invention is recorded in the notification apparatus, but the program 21 may be acquired from external equipment via communication. The program 21 may be recorded on a recording medium so as to be readable by a computer. A magnetic recording medium, an optical recording medium, a semiconductor memory device, or the like can be used as the recording medium.

### 7. Configurations Supported by Above Embodiments

The above embodiments are specific examples of the following configurations.

### Configuration 1

A notification apparatus includes: a biological information acquisition unit configured to acquire biological information about a user; an external environment recognition unit configured to recognize an external environment; a physical condition evaluation unit configured to evaluate a physical condition of the user, based on the biological information; and a notification control unit configured to notify the user of notification information, based on an evaluation result from the physical condition evaluation unit, in which the notification control unit recognizes the external environment of the user via the external environment recognition unit and includes predetermined information based on the external environment in the notification information, when detecting that the physical condition of the user is equal to or lower than a predetermined level based on the evaluation result from the physical condition evaluation unit.

According to this configuration, processing of recognizing the external environment of the user and the like becomes unnecessary and it is possible to provide appropriate notification while avoiding excessive notification, an increase in processing quantity, and the like when the physical condition of the user is not equal to or lower than the predetermined level, since the external environment of the user is recognized when the physical condition of the user is equal to or lower than the predetermined level and the predetermined information based on the external environment is included in the notification information.

### Configuration 2

The notification apparatus according to Configuration 1, in which the physical condition evaluation unit evaluates a plurality of intellectual functions relating to the physical condition of the user, based on the biological information, and the notification control unit notifies, as the notification information, the user of the predetermined information, after notifying the user of information based on an intellectual function with the lowest evaluation.

According to this configuration, it is possible to prioritize notifying the user of information based on an important intellectual function relating to the physical condition over notifying the user of the predetermined information based on the environment information, and to provide appropriate notification.

### Configuration 3

The notification apparatus according to Configuration 1 or 2 further includes a getting-in detection unit configured to detect whether the user has not gotten in or has gotten in a target vehicle, in which the external environment being a recognition target of the external environment recognition unit is changed, in accordance with whether the user has not gotten in or has gotten in the target vehicle.

According to this configuration, it is possible to provide information based on the environment information of which the user is preferably notified in accordance with whether the user has not gotten in or has gotten in the target vehicle, and to provide appropriate notification.

### Configuration 4

The notification apparatus according to Configuration 3, in which the notification information includes advice relating to driving of the user, and the external environment being the recognition target includes road traffic information, when the user has gotten in the target vehicle and a destination of the user has been set.

According to this configuration, it is possible to notify the user of notification information taking into account the physical condition and road traffic circumstances to the destination, and to provide appropriate notification, when the physical condition of the user is unfavorable and the user has gotten in the target vehicle.

### Configuration 5

The notification apparatus according to Configuration 4, in which the notification control unit performs change processing of changing to a travel route taking into account the physical condition of the user, based on the road traffic information and the physical condition of the user acquired from the evaluation result from the physical condition evaluation unit.

According to this configuration, it is possible to provide a more appropriate travel route.

### Configuration 6

The notification apparatus according to any one of Configurations 1 to 5, in which the physical condition evaluation unit evaluates a plurality of intellectual functions relating to the physical condition of the user, based on the biological information, the notification apparatus further includes a speech output unit configured to perform speech output encouraging a response from the user relating to an intellectual function with the lowest evaluation, when detecting that the physical condition of the user is equal to or lower than the predetermined level, and the notification control unit includes response handling information based on the response from the user in the notification information.

According to this configuration, it is possible to notify the user of more appropriate information, via the dialog with the user.

### Configuration 7

The notification apparatus according to Configuration 6, in which when the response from the user is a positive response relating to the intellectual function with the lowest evaluation, the notification control unit identifies a physiological indicator to be improved based on the intellectual function and notifies the user of advice relating to the identified physiological indicator.

According to this configuration, it is possible to notify the user of more appropriate information for improving the decreased intellectual function of the user, and to notify the user of more appropriate information.

### Configuration 8

A notification method executed by a notification apparatus includes: a biological information acquisition step of acquiring biological information about a user; an external environment recognition step of recognizing an external environment; a physical condition evaluation step of evaluating a physical condition of the user, based on the biological information; and a notification control step of notifying the user of notification information, based on an evaluation result of the physical condition evaluation step, in which in the notification control step, the external environment of the user is recognized in the external environment recognition step and predetermined information based on the external environment is included in the notification information, when detecting that the physical condition of the user is equal to or lower than a predetermined level based on the evaluation result of the physical condition evaluation step.

According to this configuration, it is possible to provide appropriate notification while avoiding excessive notification, an increase in processing quantity, and the like.

### Configuration 9

A non-transitory computer readable a recording medium recording a program causes a notification apparatus controlled by a computer to function as: a biological information acquisition unit configured to acquire biological information about a user; an external environment recognition unit configured to recognize an external environment; a physical condition evaluation unit configured to evaluate a physical condition of the user, based on the biological information; and a notification control unit configured to notify the user of notification information, based on an evaluation result from the physical condition evaluation unit, in which the notification control unit recognizes the external environment of the user via the external environment recognition unit and includes predetermined information based on the external environment in the notification information, when detecting that the physical condition of the user is equal to or lower than a predetermined level based on the evaluation result from the physical condition evaluation unit.

According to this configuration, it is possible to provide appropriate notification while avoiding excessive notification, an increase in processing quantity, and the like.

### REFERENCE SIGNS LIST

1 communication terminal
5 wearable device
6 vitals sensor
7 communication unit
10 processor
11 information acquisition unit
12 intellectual function evaluation unit (biological information acquisition unit, external environment recognition unit)
13 getting-in detection unit
14 dialog unit (speech acquisition unit)
15 speech evaluation unit
16 notification control unit
17 vehicle control unit
18 clock unit (external environment recognition unit)
20 memory
21 program
22 map information
23 biological information database
24 driving behavior information database
30 communication unit
31 camera
32 acceleration sensor
33 GNSS sensor
34 display
35 speaker
36 microphone
100 vehicle (target vehicle)
110 ECU
121 navigation apparatus
130 front camera
131 driver monitor camera
132 display
133a, 133b speaker
150 terminal holder
160 wearable device
200 communication network
210 traffic information server
211 service provision server
D driver
Db biological information
Dv driving behavior information

1. A notification apparatus, comprising:
a biological information acquisition unit configured to acquire biological information about a user;
an external environment recognition unit configured to recognize an external environment;
a physical condition evaluation unit configured to evaluate a physical condition of the user, based on the biological information; and
a notification control unit configured to notify the user of notification information, based on an evaluation result from the physical condition evaluation unit, wherein
the notification control unit recognizes the external environment of the user via the external environment recognition unit and includes predetermined information based on the external environment in the notification information, when that the physical condition of the user is equal to or lower than a predetermined level is detected based on the evaluation result from the physical condition evaluation unit.

2. The notification apparatus according to claim 1, wherein
the physical condition evaluation unit evaluates a plurality of intellectual functions relating to the physical condition of the user, based on the biological information, and
the notification control unit notifies, as the notification information, the user of the predetermined information, after notifying the user of information based on an intellectual function with the lowest evaluation.

3. The notification apparatus according to claim 1, further comprising a getting-in detection unit configured to detect whether the user has not gotten in or has gotten in the target vehicle, wherein
the external environment being a recognition target of the external environment recognition unit is changed, in accordance with whether the user has not gotten in or has gotten in the target vehicle.

4. The notification apparatus according to claim 3, wherein
the notification information includes advice relating to driving of the user, and
the external environment being the recognition target includes road traffic information, when the user has gotten in the target vehicle and a destination of the user has been set.

5. The notification apparatus according to claim 4, wherein the notification control unit performs change processing of changing to a travel route taking into account the physical condition of the user, based on the road traffic information and the physical condition of the user acquired from the evaluation result from the physical condition evaluation unit.

6. The notification apparatus according to claim 1, wherein
the physical condition evaluation unit evaluates a plurality of intellectual functions relating to the physical condition of the user, based on the biological information,
the notification apparatus further comprises a speech output unit configured to perform speech output encouraging a response from the user relating to an intellectual function with the lowest evaluation, when that the physical condition of the user is equal to or lower than the predetermined level is detected, and
the notification control unit includes response handling information based on the response from the user in the notification information.

7. The notification apparatus according to claim 6, wherein when the response from the user is a positive response relating to the intellectual function with the lowest evaluation, the notification control unit identifies a physiological indicator to be improved based on the intellectual function and notifies the user of advice relating to the identified physiological indicator.

8. A notification method executed by a notification apparatus, comprising:
a biological information acquisition step of acquiring biological information about a user;
an external environment recognition step of recognizing an external environment;
a physical condition evaluation step of evaluating a physical condition of the user, based on the biological information; and
a notification control step of notifying the user of notification information, based on an evaluation result of the physical condition evaluation step, wherein
in the notification control step, the external environment of the user is recognized in the external environment recognition step and predetermined information based on the external environment is included in the notification information, when that the physical condition of the user is equal to or lower than a predetermined level is detected based on the evaluation result of the physical condition evaluation step.

9. A non-transitory computer readable a recording medium recording a program for causing a notification apparatus controlled by a computer to function as:
a biological information acquisition unit configured to acquire biological information about a user;
an external environment recognition unit configured to recognize an external environment;
a physical condition evaluation unit configured to evaluate a physical condition of the user, based on the biological information; and
a notification control unit configured to notify the user of notification information, based on an evaluation result from the physical condition evaluation unit, wherein
the notification control unit recognizes the external environment of the user via the external environment recognition unit and includes predetermined information based on the external environment in the notification information, when that the physical condition of the user is equal to or lower than a predetermined level is detected based on the evaluation result from the physical condition evaluation unit.
